(19) United States
(12) Patent Application Publication
(10) Pub. No.: US 2009/0266665 A1
(43) Pub. Date: Oct. 29, 2009

(54) Hydrodynamic torque converter

(75) Inventors: Christian HUEGEL, Rheinau (DE); Stephan MAIENSCHEIN, Baden-Baden (DE)

Correspondence Address: Davidson, Davidson & Kappel, LLC, 485 7th Avenue, 14th Floor, New York, NY, 10018, US

(73) Assignee: Luk Lamellen und Kupplungsbau Beteiligungs KG, Buehl (DE)

(21) Appl. No.: 12/386,647

(22) Filed: Apr. 21, 2009

Related U.S. Application Data
(63) Continuation of application No. PCT/DE2007/001747, filed on Sep. 27, 2007.

(30) Foreign Application Priority Data
Oct. 21, 2006 (DE) 10 2006 049 730.9

(51) Int. Cl. F16H 45/02

(52) U.S. Cl. 192/3.29

(57) ABSTRACT

A hydrodynamic torque converter having a housing which may be connected or is connectable torque proof to a drive unit and which has a converter cover to which is fastened a hub in which, radially at the inside, an end of a transmission input shaft is arranged in a rotatable fashion and on which, radially at the outside, a piston of a converter bypass clutch is mounted in an axially movable and if appropriate rotatable fashion is provided. The hub may be caulked with the converter cover.

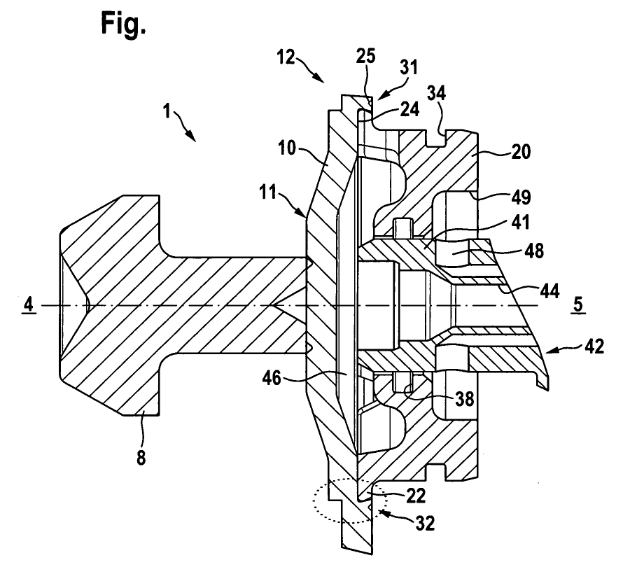

This is a continuation of prior International Application PCT/DE2007/001747, filed Sep. 27, 2007, which claims priority to German Patent Application DE 10 2006 049 730.9, filed Oct. 21, 2006, the entire disclosures of which are hereby incorporated by reference herein.

The invention relates to a hydrodynamic torque converter with a housing, which is connectable or connected torque proof with a drive unit, and which comprises a converter cover at which a hub is mounted in which an end of a transmission input shaft is disposed on the radial inside and at which hub a piston of a converter lockup clutch is supported axially movable and possibly rotatable.

### BACKGROUND OF THE INVENTION

A hydrodynamic torque converter with a converter lockup clutch is known from the German patent application publication DE 198 38 445 A1, in which a central pin is connected to the converter housing through welding.

### BRIEF SUMMARY OF THE INVENTION

It is an object of the invention to provide a hydrodynamic torque converter which is simple in configuration and economical to produce.

The object is accomplished in a hydrodynamic torque converter with a housing, which is connectable or connected torque proof with a drive unit, and which housing comprises a converter cover, at which a hub is mounted, in which one end of a transmission input shaft is rotatably supported on the radial inside and at which a piston of a converter lockup clutch is supported axially movable and possibly rotatably supported, wherein the hub is calked with the converter cover. During the calking, the material of the hub and/or of the converter cover is displaced or deformed in a controlled manner, in particular deformed cold, so that a permanent connection between the hub and the converter cover is provided. Calking the hub, among other things, yields the advantage that when producing the connection, no residual contamination is generated in the area between the hub and the converter cover, which is difficult to access. Additionally, finishing functional surfaces, which is required e.g. for welding, can be omitted. The torque converter comprises a pump shell, a turbine shell and possibly a stator.

A preferred embodiment of the hydrodynamic torque converter is characterized in that the converter cover comprises an indentation in which an axial section of the hub is received. The indentation is preferably created by forming, in particular by coining, a sheet metal component.

Another preferred embodiment of the hydrodynamic torque converter is characterized in that the inner contour of the indentation is adapted to the outer contour of the axial section of the hub. The converter cover and the hub respectively comprise a circular contour.

Another preferred embodiment of the hydrodynamic torque converter is characterized in that plural calking locations are provided in the converter cover radially outside of the hub. Preferably, the caulking locations are equally distributed over a circumference of the converter cover.

Another preferred embodiment of the hydrodynamic torque converter is characterized in that the piston is centered on the hub. Preferably, a seal element, preferably a seal ring, is provided between the piston and the hub.

Further preferred embodiments of the hydrodynamic torque converter are characterized in that the hub is configured as pressure cast component, in particular as an aluminum pressure cast component, or as a sintered component. Thus, the production cost can be reduced.

The invention furthermore relates to a torque transfer device, in particular in the drive train of a motor vehicle; with a transmission input shaft and a hydrodynamic torque converter as described supra for transmitting torque between the drive unit and a transmission. Preferably, a torsion vibration damper is integrated into the torque transfer device.

### BRIEF DESCRIPTION OF THE DRAWING

Further advantages, features and details of the invention can be derived from the subsequent description, in which an embodiment is described in detail with reference to the drawing.

In the described FIGURE, a hydrodynamic torque converter according to an embodiment of the invention is shown in a detail in a longitudinal cut view.

### DETAILED DESCRIPTION

A drive train 1 of a motor vehicle is indicated in the attached FIGURE. Between a drive unit 4, in particular a combustion engine from which a crank shaft extends, and a transmission 5, a torque transfer device with a pilot boss 8 is indicated. The pilot boss 8 is used for positioning the torque transfer device during assembly relative to the crank shaft, which is not shown. The pilot boss 8 is mounted at a converter cover 10 of a housing 11 of a hydrodynamic torque converter 12. The converter cover 10 is connected torque proof on the radial outside (not shown) with the crank shaft of the combustion engine.

In the housing 11 of the hydrodynamic torque converter 12, a pump shell (not shown) is disposed, which is connected torque proof to the housing 11. The hydrodynamic torque converter 12 furthermore comprises a stator which is not shown. A turbine shell is disposed in the flow circuit of a fluid flow of the torque converter, which turbine shell is rotatably supported on a drive hub. A piston of a converter lockup clutch is supported on a hub 20 axially movable and possibly rotatable between the housing 11 and the turbine shell.

The hub 20 comprises a radially outward extending mounting flange 22 on its face oriented towards the combustion engine 4. The mounting flange 22 is received in a circular indentation 24, which is recessed in the converter cover 10. The indentation 24 is demarcated on the radial outside by a rim portion 25. Two caulking locations 31, 32 are indicated in the rim portion 25 of the indentation 24 of the converter cover 10. The mounting flange 22 of the hub 20 is caulked with the rim portion 25 of the indentation of the converter cover 10 at the caulking locations 31, 32. The hub 20 is fixated at the converter cover 10 by the axial caulking.

The hub 20 comprises a ring groove 34 with rectangular cross section at the radial outside. The ring groove 34 is used for receiving a seal ring which is used for sealing the inner section between the piston and the converter lockup clutch and the hub 20. The hub 20 comprises another ring groove 38 on the radial inside, which ring groove also comprises a rectangular cross section. The ring groove 38 is used for receiving a seal ring, which is used for sealing the inner section between the hub 20 and an end 41 of the transmission input shaft 42.

The transmission input shaft 42 extends from the transmission 5 and comprises a central pass-through hole 44, which leads into a pressure cavity 46, which is provided between the converter cover 10 and the hub 20. The transmission input shaft 42 comprises another pass-through hole 48, which is independent from the central pass-through hole 44, which pass-through hole 48 leads into an annular cavity 49, which is demarcated on the radial outside towards the combustion engine 4 by the hub 20.

What is claimed is:

1. A hydrodynamic torque converter comprising:
a housing connectable or connected torque proof with a drive unit, the housing comprising a converter cover, at which a hub is fixated, in which an end of a transmission input shaft is rotatably disposed on a radial inside, and at which a piston of a converter lockup clutch is disposed axially movable and possibly rotatable on the radial outside, wherein the hub is caulked with the converter cover.

2. A hydrodynamic torque converter according to claim 1, wherein the converter cover comprises an indentation, in which an axial section of the hub is received.

3. A hydrodynamic torque converter according to claim 2, wherein the inner contour of the indentation is adapted to the outer contour of the axial section of the hub.

4. A hydrodynamic torque converter according to claim 1, wherein plural calking locations are provided on the radial outside of the hub in the converter cover.

5. A hydrodynamic torque converter according to claim 1, wherein the piston is centered on the hub.

6. A hydrodynamic torque converter according to claim 1, wherein the hub is configured as a pressure cast component, in particular as an aluminum pressure cast component.

7. A hydrodynamic torque converter according to claim 1, wherein the hub is configured as a sintered component.

8. A torque transmission device, in particular in the drive train of a motor vehicle, with a transmission input shaft and a hydrodynamic torque converter according to claim 1 for transmitting torque between the drive unit and a transmission.
